(19) United States
(12) Patent Application Publication
(10) Pub. No.: US 2003/0003793 A1
(43) Pub. Date: Jan. 2, 2003

(54) Electrical connector with distribution contacts

(76) Inventor: Che-Chia Chang, Taipei (TW)

Correspondence Address: TROXELL LAW OFFICE PLLC, 5205 LEESBURG PIKE, SUITE 1404, FALLS CHURCH, VA, 22041, US

(21) Appl. No.: 09/898,113

(22) Filed: Jul. 2, 2001

(51) Int. Cl. H01R 4/24; H01R 4/26; H01R 11/20

(52) U.S. Cl. 439/402

(57) ABSTRACT

The connector of the present invention comprises at least one contact plate or a plurality of contact plates, wherein one end of each contact plate has a plurality of terminals or pins and another end has a connecting section. Because the pins carry the same voltage and are connected together, the total voltage or current capacity of the contact plate is increased. Since the terminals or pins are connected to form a contact plate, only one signal wire is required to be connected to a contact plate that distributes the signal or voltage of the wire to a plurality of pins instead of a wire or jumper connecting to each of the desired pins as in the conventional method.

### BACKGROUND OF THE INVENTION

1. Field of Invention

The present invention relates generally to an electrical connector. More particularly, the present invention relates to an electrical connector with distribution contacts.

2. Description of the Related Art

Present-day society increasingly relies on computers, computer systems, computer software applications and computer devices as computers become more essential in everyday life. With the increasing demands of computer applications in various areas, the utility and usefulness of computers increase, and integrated circuit (IC) connections become more complex. Various techniques have been developed to increase the number of IC device connections while providing a more compact computer with high performance.

Devices such as hard disk drives or cd-rom drives or peripherals such as printers or external mass storage devices are connected to a host computer by cables. These cables have connectors and contacts attached to the wires in the cables.

There are common methods for connecting wires to the pins of the connectors. However, these methods require considerable time and skill. For example, with some methods, during the process of attaching each wire to each pin, the temperature has to be controlled carefully so that the wire can be bonded to the pin strongly without overheating the wire. Other methods require considerable force, and if too much force is applied, the copper portion of the wire can be damaged or even break off. Additionally, each pin has to be connected to every wire in order to make the proper connection. In a 40 pin connector, for example, 40 individual wires need to be attached or connected to the connector contact. Therefore, making the connections is time consuming, resulting in an increased production cost.

As a result, an improved electrical connector that reduces production time, defects, and lowers production costs is needed.

### SUMMARY OF THE INVENTION

It is an object of the present invention to provide a more compact, reliable and cost-effective connector by utilizing an improved connector with improved connections and contacts.

The previous example describes a one wire to one contact connector where each contact is attached to only one wire. In some situations a wire or a plurality of wires must be connected to a plurality of contacts or pins of the connector. This can be accomplished by connecting jumpers between the plurality of contacts. However, this increases the production time and increases the probability of a damaged or imperfect part.

As a result, an improved connector incorporating contacts that distribute a signal or voltage to a plurality of pins or contacts has been developed. Therefore a wire or a plurality of wires can be connected to a plurality of pins of the connector without requiring jumpers to make the multiple connections.

Both the foregoing general description and the following detailed description are exemplary and explanatory only and are not restrictive of the invention, as claimed.

### BRIEF DESCRIPTION OF THE DRAWINGS

The accompanying drawings are included to provide a further understanding of the present invention, and are incorporated in and constitute a part of this specification. The drawings illustrate embodiments of the invention and, together with the description, serve to explain the principles of the invention. In the drawings,

FIG. 1 is an assembly view showing a connector with distribution contacts in accordance with an embodiment of the present invention;

FIG. 1A is a drawing showing an alternative cover of a connector in accordance with an embodiment of the present invention;

FIG. 2 is a drawing showing a contact plate of a connector in accordance with an embodiment of the present invention;

FIG. 3 is a magnified view showing a portion of a contact plate shown in FIG. 2, in accordance with an embodiment of the present invention;

FIG. 4 is a drawing showing a distribution contact plate of a connector in accordance with an embodiment of the present invention;

FIG. 5 is a drawing showing a solder-able contact plate of a connector in accordance with an embodiment of the present invention; and

FIG. 6 is a drawing showing a crimp-able contact plate of a connector in accordance with an embodiment of the present invention.

### DETAILED DESCRIPTION OF THE PREFERRED EMBODIMENTS

It is an object of the present invention to provide a more compact, reliable and cost-effective connector by utilizing a connector with improved connections and contacts allowing a wire or wires to be electrically connected to a plurality of contact pins or points.

The previous example describes a one wire to one contact connector where each contact is attached to only one wire. In some situations a wire or a plurality of wires must be connected to a plurality of contacts or pins of the connector. This can be accomplished by connecting jumpers between the plurality of contacts. However, this increases the production time and increases the probability of a damaged or imperfect part.

As a result, an improved connector incorporating contacts that distribute a signal or voltage to a plurality of pins or contacts has been developed. Therefore a wire or a plurality of wires can be connected to a plurality of pins of the connector without requiring jumpers to make the multiple connections.

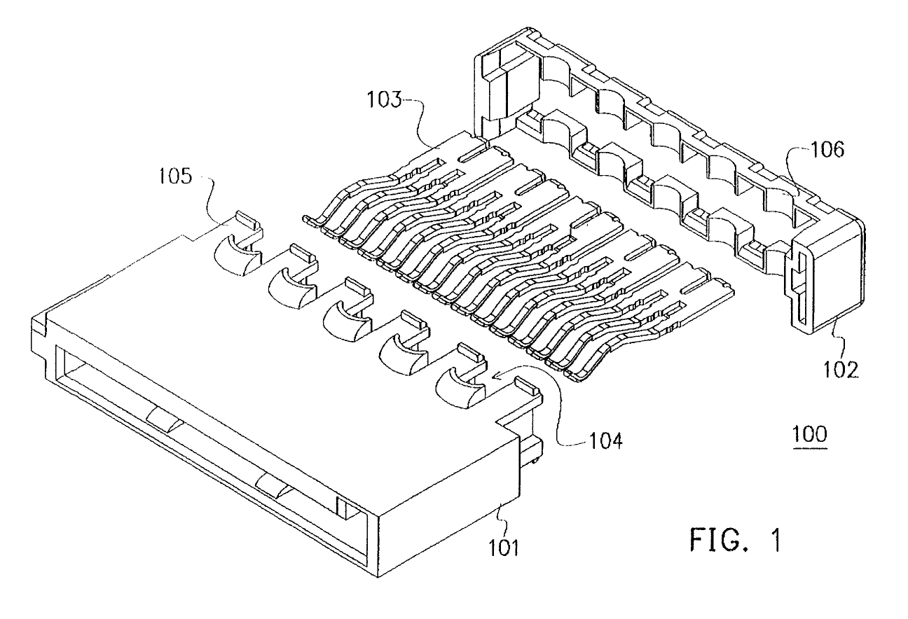

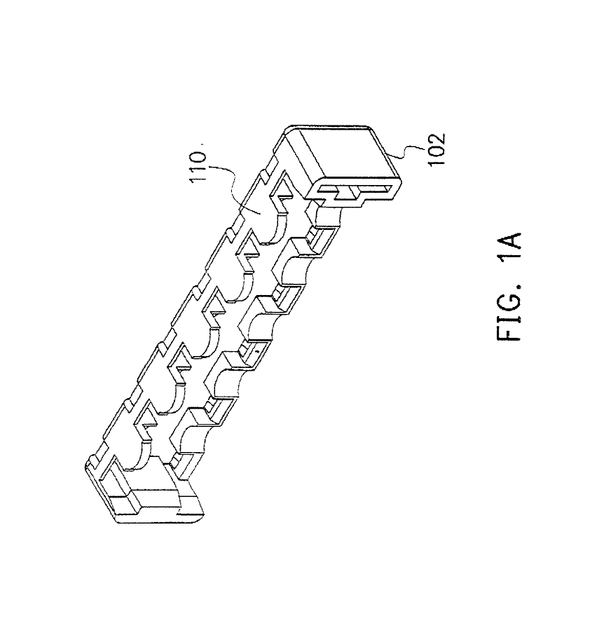

Refer to FIG. 1, which illustrates an assembly view of a connector in accordance with a preferred embodiment of the present invention. A connector 100 comprises: a housing 101, a cover 102 and a contact plate 103. A housing 101 has a plurality of slots 104 and protrusions 105. The protrusions 105 are arranged in such a way so as to be separated from each other by the slots 104 to form a finger-like structure. A cover 102 has a plurality of concave surfaces 106. Also, refer to FIG. 1A, which is a drawing showing an alternative cover according to an embodiment of the present invention. The top row of concave surfaces 106 that are shown in FIG. 1 has been replaced with protrusions 110 as shown in FIG. 1A. Locations of the concave surfaces 106 and the protrusions 110 of the cover 102 are matched and correspond to positions of the slots 104 and the protrusions 105 of the housing 101. The housing 101, cover 102, and contact plate 103 are examples and do not limit the present invention to those types shown. Various other types of housing are also envisioned depending on the size and number of pins required.

During an integrating process, at least one contact plate 103 is inserted into the housing 101, and the cover 102 is integrated onto a top part of the housing 101. For example purposes, FIG. 1 shows five contact plates but the number of contact plates 103 can be increased or decreased as determined by the number of contact plates 103 required by the connector.

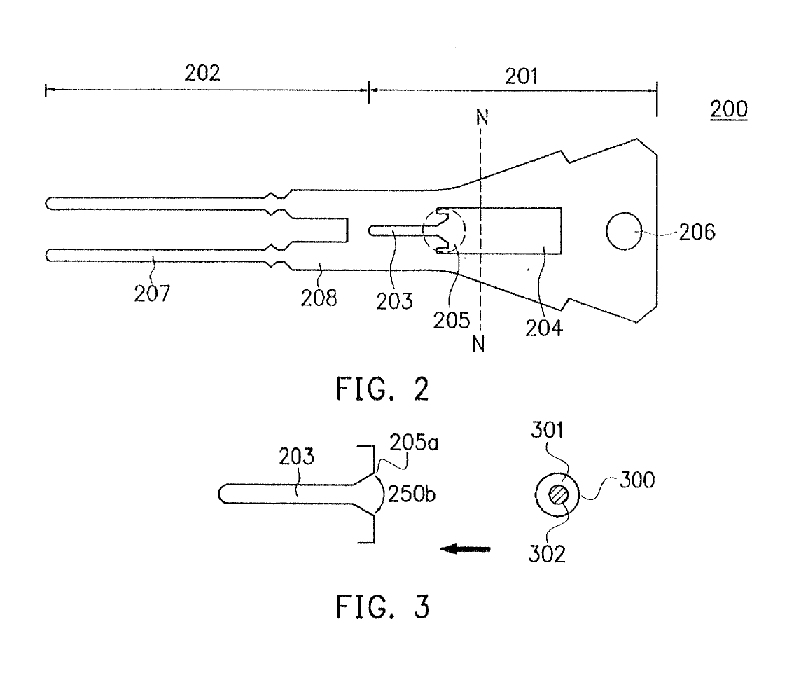

FIG. 2 is a drawing showing a contact plate of a connector in accordance with an embodiment of the present invention. Referring to FIG. 2, the contact plate 200 comprises a top portion 201 and a forked portion 202.

The top portion 201 comprises an oblong-shaped slot, which is an insulation displacement contact (IDC) section 203 extending into a wider hole 204 via a Y-shaped transition portion 205. The circular hole 206 is for positioning the contact plate during a fabrication process. In an integrating process, the top portion 201 will be broken off along a line N-N.

A standard insulated wire can be inserted into the IDC section 203. The wire is inserted through the Y-shaped transition portion 205 into the IDC section 203.

FIG. 3 illustrates a magnified view of a portion of the contact plate according to an embodiment of the present invention. Referring to FIG. 3, the Y-shaped transition portion 205 comprises a pair of sharp edges 205a and a Y-shaped opening 205b. A distance between the sharp edges 205a is smaller than an outer diameter of the conductive wire portion 302 contained in the wire 300. When the wire 300 is inserted into the Y-shaped opening 205b, the sharp edges 205a will cut through an insulating portion 301 of the wire 300, and a conductive wire portion 302 of the wire 300 is exposed and comes into contact with the IDC section 203. The Y-shaped transition portion 205 is designed in such way that it allows the wire to electrically connect to the terminals without soldering or crimping and without any damage to the conductive wire portion 302 of the wire 300.

Referring again to FIG. 2, the forked portion 202 of the contact plate 200 comprises two conducting terminals, pins or leads 207, which are connected at one end into a contact part 208, thus forming a fork-shaped structure. The conducting terminals, pins or leads 207 can be made of, for example, copper alloy for good conductivity.

After the wire is connected to the contact plate, any signal or voltage level that passes through the wire, is distributed to a plurality of contact pins or terminals of the connector. In this way, a wire or a plurality of wires can be connected to a plurality of pins of the connector without requiring jumpers to make the multiple connections. In the conventional method a wire is attached to a first contact. Then one end of a jumper is connected to the wire or first contact. Finally, the other end of the jumper is connected to the second contact. This requires 3 connecting steps during the manufacturing process. However, with the present invention, only one connection is required where the wire is connected to the contact pad and the contact pad distributes the signal to the appropriate contact terminals or pins.

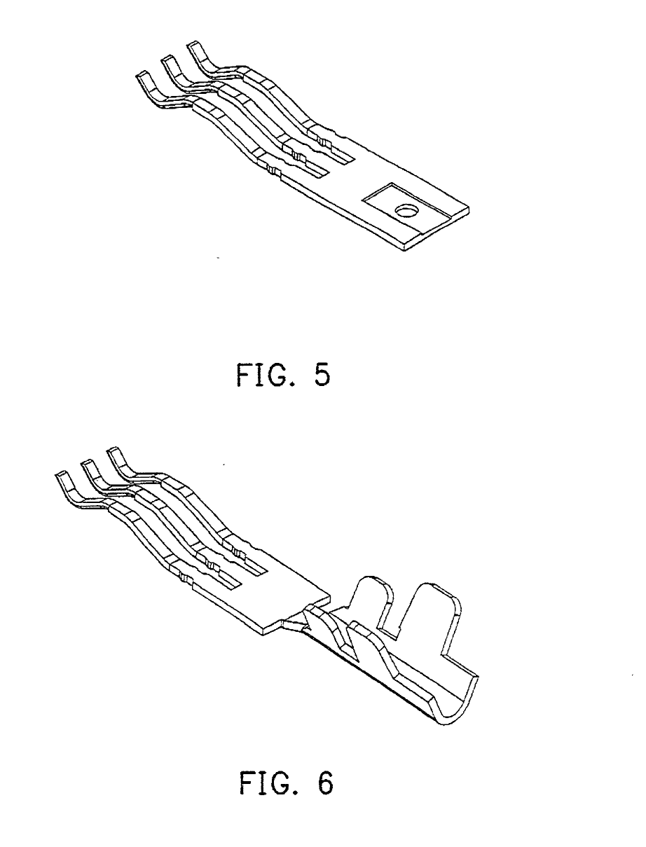

The embodiments given are using an insulation displacement contact method for attaching the wire or wires to the contact plate or pins. However, in other embodiments of the present invention, the IDC connecting method is replaced by soldering, crimping, or other connecting methods or means. Two alternative connecting methods are shown in the drawings. Refer to FIG. 5, which is a drawing showing a contact plate of a connector in accordance with an embodiment of the present invention wherein the wire or wires are to be soldered to the contact plate. Also, refer to FIG. 6, which is a drawing showing a contact plate of a connector in accordance with an embodiment of the present invention wherein the wire or wires are to be crimped to the contact plate.

The connector of the present invention comprises at least one contact plate or a plurality of contact plates, wherein one end of each contact plate has a plurality of terminals or pins, such as two pins, for example, and another end has a connecting section. Each pin can carry a signal, current or voltage, for example 3V, 5V, or 12V. The pins that carry the same signal, current or voltage are then combined together into one contact plate. Because the pins carry the same voltage and are connected together, the total voltage or current capacity of the contact plate is increased. Since the pins are connected to form a contact plate, only one signal wire is required to connect to a contact plate instead of every wire connecting to every pin as in the conventional method. Therefore, the number of wire connections is reduced.

The contact plate of the present invention is not limited to the number of conducting forked structures in each contact plate. Also, the number of contact plates can be combined into more than two conducting structures.

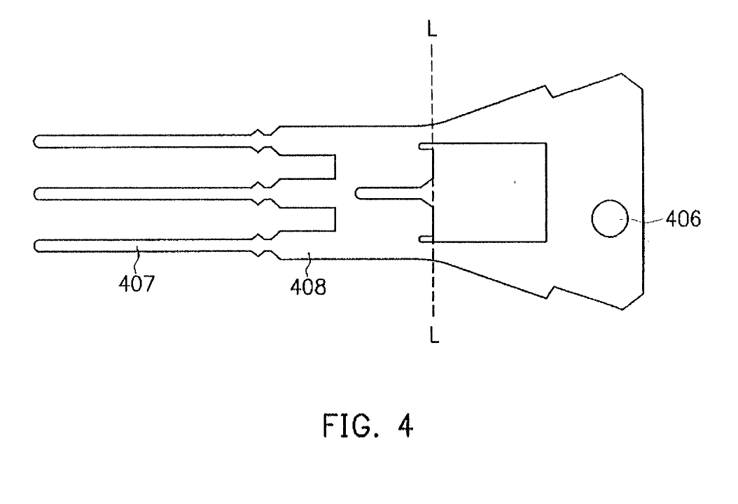

FIG. 4 illustrates a contact plate of a connector with distribution contacts in accordance with another embodiment of the present invention. Based on the same principles and theory, a contact plate comprising three terminals or pins 407 is shown. The number of terminals or pins can be any quantity and is not limited to two or three as shown in the drawings. In fact, as shown above, increasing the number of terminals or pins increases the value of the present invention. The present invention only requires one connection per contact pin in order to distribute a signal or voltage to a plurality of pins. However, with the conventional method, if a signal is to be sent to four pins a total of seven connections is required.

Advantages of the present invention are at least;

1. The number of connections that are required is reduced; therefore, less time is required and the cost is reduced.

2. The total voltage or current capacity of the contact plate is greatly increased.

3. The connection between wires to pins or wires to wires is more effective and rapid. No damage occurs to the conductive portion of the wire.

4. The cost of production is significantly reduced, and the integrating process and fabrication process are simplified.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. An electrical connector comprising:
a contact plate comprising a plurality of conductive terminals electrically coupled to the contact plate;
at least one conductive wire connected to the contact plate;
wherein the contact plate distributes signals received via the at least one conductive wire, to the plurality of conductive terminals; and
a housing for holding the contact plate;

2. The connector of claim 1, wherein the conductive wire is connected to the contact plate with an insulation displacement contact.

3. The connector of claim 1, wherein the conductive wire is connected to the contact plate by solder.

4. The connector of claim 1, wherein the conductive wire is connected to the contact plate by crimping.

5. The connector of claim 1, wherein the contact plate and conductive terminals are made of copper alloy.

6. An electrical connector comprising:
a housing having a plurality of first protrusions on one end, wherein the first protrusions are separated from each other by a plurality of slots;
a contact plate having a plurality of conducting structures, wherein the conducting structures are connected at one end to form a contact part, and the contact plate is inserted into the housing; and
a cover having a plurality of indentations formed on one side, wherein positions of the indentations match positions of the slots, wherein the cover is fit onto the contact plate and the housing.

7. The connector of claim 6, wherein the conductive wire is connected to the contact plate with an insulation displacement contact.

8. The connector of claim 6, wherein the conductive wire is connected to the contact plate by solder.

9. The connector of claim 6, wherein the conductive wire is connected to the contact plate by crimping.

10. The connector of claim 6, wherein the contact plate and conductive terminals are made of copper alloy.

11. An electrical connector comprising:
a housing having a plurality of first protrusions on one end, wherein the first protrusions are separated from each other by a plurality of slots;
a contact plate having a plurality of conducting structures, wherein the conducting structures are connected at one end to form a contact part, and the contact plate is inserted into the housing; and
a cover having a plurality of second protrusions formed on one side, wherein positions of the second protrusions match positions of the slots, wherein the cover is fit onto the contact plate and the housing.

12. The connector of claim 11, wherein the conductive wire is connected to the contact plate with an insulation displacement contact.

13. The connector of claim 11, wherein the conductive wire is connected to the contact plate by solder.

14. The connector of claim 11, wherein the conductive wire is connected to the contact plate by crimping.

15. The connector of claim 11, wherein the contact plate and conductive terminals are made of copper alloy.

16. An electrical connector comprising:
a housing having a plurality of first protrusions on one end, wherein the first protrusions are separated from each other by a plurality of slots;
a contact plate having a plurality of sets of conducting structures, wherein the conducting structures of each set are connected together at one end to form a contact part, and an oblong-shaped slot is formed on the contact part, the contact plate being inserted into the housing; and
a cover having a hollow in the middle and a plurality of second protrusions formed on one side, wherein a portion of the second protrusions have a concave surface, the second protrusions being separated from each other by a plurality of holes, and positions of the second protrusions and the holes of the cover are matched and correspond to positions of the slots and first protrusions of the housing, wherein the cover is fit onto the contact plate and the housing.

17. The connector of claim 16, wherein the conductive wire is connected to the contact plate with an insulation displacement contact.

18. The connector of claim 16, wherein the conductive wire is connected to the contact plate by solder.

19. The connector of claim 16, wherein the conductive wire is connected to the contact plate by crimping.

20. The connector of claim 16, wherein each set of the conducting structures comprises two conducting structures.

21. The connector of claim 16, wherein each set of the conducting structures comprises three conducting structures.

22. The connector of claim 16, wherein the conducting structures are made of copper alloy.
